(19) United States
(12) Patent Application Publication
(10) Pub. No.: US 2010/0006802 A1
(43) Pub. Date: Jan. 14, 2010

(54) Display for image and manufacturing method at the same

(76) Inventor: Woo-Sung Kim, Gangwon-do (KR)

Correspondence Address: Revolution IP, PLLC, 5234 Capon Hill Place, Burke, VA, 22015, US

(21) Appl. No.: 12/522,196

(22) PCT Filed: Jan. 7, 2008
(86) PCT No.: PCT/KR08/00067

§ 371 Date: Jul. 6, 2009

(30) Foreign Application Priority Data
Jan. 5, 2007 (KR) 10-2007-0001336

(51) Int. Cl. C09K 11/02

(52) U.S. Cl. 252/301.36

(57) ABSTRACT

The present invention relates to a display, more specifically, to an image display improving a hot spot and a viewing angle and solving problems caused by the chemical characteristic of materials, even if implementing a display by projection-type, and manufacturing method at the same.

In order to this, the present invention provides an image display comprising of background materials and masterbatch achieving a performance of the display by mixing with the background materials; wherein the masterbatch comprises fluorescent pigments of red (R), green (G) and blue (B) implementing colors, a carbon black, a light diffuser and a UV stabilizer.

### TECHNICAL FIELD

The present invention relates to a display, more specifically, to an image display improving a hot spot and a viewing angle and solving problems caused by the chemical characteristic of materials, even if implementing a display by projection-type, and manufacturing method at the same.

### BACKGROUND ART

An image display by projection-type has been utilized as limited use such as a theater, but recently, the field thereof is broadening to television or display for advertisement and so on.

Conventionally, the method for manufacturing a display is carried out by processing a panel to form a lens and induce a diffraction of light, which is one kinds of method using the combination of fresnel lens and lenticular lens. This method has applied to a display panel of projection television. Otherwise, there is other method that a coating film is adhered to the panel on which lens is formed.

However, according to the said traditional methods, it is not possible to basically improve the problems of a Hot spot caused by the difference of color tone from various light sources and by the difference of light brightness; and a trouble of viewing angle. Accordingly, the preexisted television of the projection type has still the problem related to viewing angle, and can not form clear image under natural illumination and artificial illumination.

Furthermore, since there is a limitation in display materials for background medium, which can be used in lens-processing, there is also a limitation in manufacturing a panel having a particular intensity, thickness or chemical characteristic.

Moreover, when screen is set up outdoor, it is needed to stand the external conditions such as wind, temperature, snow, rain etc., but traditional projection screen is easily corroded or discolored in case of exposing in UV light or rain.

### SUMMARY OF THE INVENTION

Accordingly, the present invention is contrived in order to solve the problems described as above, a main object of the present invention is to provide an image display improving a hot spot and a viewing angle and solving a problem caused by the chemical characteristic of materials, even if implementing a display by projection-type; and a manufacturing method at the same.

In order to achieve the above object, in one aspect, the present invention provides an image display comprising of background materials and masterbatch achieving a performance of the display by mixing with the background materials; wherein the masterbatch comprises fluorescent pigments of red (R), green (G) and blue (B) implementing colors, a carbon black, a light diffuser and a UV stabilizer.

The used background materials are any one selected from PC (PolyCarbonate), PMMA (Poly Methyl Meta Acrylate), PE (Polyethylene), PP (PolyPropylene), PI (Polyimide), Urethane or glass.

Moreover, among the fluorescent pigments, it is characterized in that red (R) is a phenyl-based pigment, green (G) is a lumilight pigment and blue (B) is tungstic acid calcium pigment.

The ratio of each fluorescent pigment and the carbon black is characterized in that red (R):green (G):blue (B):carbon black=1:50:80:5 based on the weight parts.

In the masterbatch, the ratio of the mixture comprising the carbon black and fluorescent pigments and background materials (resin) is 1/300˜1/800 based on the weight parts.

The masterbatch has a component ratio as follows: the pigment mixture comprising the carbon black:light diffuser:UV stabilizer=1/300-1/800:18˜23%:0.01˜0.05% based on the weight parts, and the rest is filled with the background materials.

In another aspect, the present invention provides a method for manufacturing an image display, the said method comprises the follow three steps:
the first step of forming an pigment mixture by mixing the background materials and each fluorescent pigment powder of red (R), green (G) and blue (B) and adding with solvent thereto to re-mix with carbon black;
the second step of composing a masterbatch by adding with the solvent to the pigment mixture containing the carbon black to mix with the powder of a light diffuser and UV stabilizer and then stirring to mix with the background materials; and
the third step of forming a mixture by mixing the background materials and the masterbatch and then molding a display.

Furthermore, as the background materials, any one of PC (PolyCarbonate), PMMA (Poly Methyl Meta Acrylate), PE (Polyethylene), PP (PolyPropylene), PI (Polyimide), Urethane or glass can be used.

In the first step, the ratio of each fluorescent pigment and carbon black is that red (R):green (G):blue (B):carbon black=1:50:80:5 based on the weight parts.

In the first step, the ratio of the mixture comprising the carbon black and fluorescent pigments and background materials (resin) is 1/300˜1/800 based on the weight parts in the masterbatch.

Furthermore, in the second step, the masterbatch has a component ratio as follows: the pigment mixture comprising the carbon black:light diffuser:UV stabilizer=1/300˜1/800:18˜23%:0.01˜0.05% based on the weight parts, and the rest is filled with the background materials.

In the third step, the ratio of the masterbatch and background materials is 1:9 based on the weight parts.

According to the present invention, the background materials and masterbatch implementing a display function are mixed at the proper ratio to realize one display, which is possible to reduce some steps in manufacturing a display compared to traditional method by lamination process. Thus, the production cost of display panel can be reduced, too.

Moreover, since the display of the present invention dose not laminated structure, it is possible to produce a panel or screen having thinner thickness, furthermore, such thin-membrane enables to process panel or screen physically or chemically to endow a filter function or lens function thereto easily.

By mixing the background materials and masterbatch at proper ratio, it is possible to control the absorption band of visible ray to obtain a desired brightness, color and resolution.

### BRIEF DESCRIPTION OF DRAWINGS

FIG. 1 shows the process of manufacturing an image display according to one embodiment of the present invention.

FIG. 2 shows a transmittance of image display according to one embodiment of the present invention.

FIG. 3 shows a reflectance of image display according to one embodiment of the present invention.

FIG. 4 shows a three-dimensional transmittance of image display according to one embodiment of the present invention, using an iconoscope.

### DETAILED DESCRIPTION OF THE INVENTION, AND PREFERRED EMBODIMENTS

To be continued, the preferable examples of the present invention are explained below in detail as referring to attached Figures.

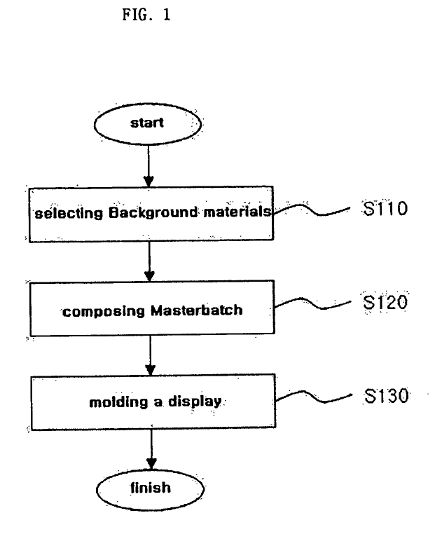

FIG. 1 shows the process of manufacturing an image display according to one embodiment of the present invention.

The image display according to the present invention comprises background materials which is a base medium and a masterbatch realizing a display by mixing with the said background materials. As referring to FIG. 1, the process of manufacturing the image display is be described below.

1) At first, the background materials are selected (S110). Herein, the materials capable of transmitting more than 70% of incident light are preferable in order to acquire a stable image. Furthermore, it is also preferable that the background materials can keep fixed shapes of image display such as projection screen and keep an intensity of display panel so as to stand external environments. Additionally, for installing in various places, the display is needed not to be shaken in the wind to hold original image and needed to overcome the conditions such as sunlight, external temperature or humidity, thus it is preferable to use the materials meeting these requirements. Therefore, PC (PolyCarbonate), PMMA (Poly Methyl Meta Acrylate), PE (Polyethylene), PP (PolyPropylene), PI (Polyimide), Urethane or glass etc. can be used as main background materials.

2) Then, a masterbatch is composed, the masterbatch implements a display by mixing with the said background materials (S120). Wherein, the masterbatch comprises fluorescent pigments of red (R), green (G) and blue (B) implementing color and carbon black as a filler of the said fluorescent pigments. The masterbatch can further comprise UV (ultraviolet) stabilizer and a light diffuser for increasing a luminance. Moreover, in the fluorescent pigments, the red (R) is a phenyl-based pigment, the green (G) is a lumilight pigment and the blue (B) is tungstic acid calcium pigment. It is more preferable to use an inorganic-based fluorescent pigment.

A carbon black is used as a filler at intervals among each fluorescent pigments, and such carbon black increases a contrast of picture quality and promotes an absorption of incident light.

The UV stabilizer comprised in the masterbatch prevents from aging by UV and improves a haze phenomenon on the surface of display, it is selected from hydroxyl, bezophenon, benzotriazoles, substitutes acrylate and so on.

The light diffuser is added to the display to improve a light-diffusion and light-transmission, resulting in increasing a luminance. The main ingredient thereof can be a calcium carbonate, calcium phosphate or other additives. An image on the display can be formed by that the incident light from projector is scattered and reflected by a light diffuser comprised in the display panel, which is the type of corpuscle.

The process of composing the masterbatch is more specifically described below.

In other words, background materials are mixed with each fluorescent pigment powder of red, green and blue to form a pigment mixture, and added with a solvent thereto to re-mix with carbon black (S121). Herein, the ratio of each fluorescent pigment and carbon black is that red:green:blue:carbon black=1:50:80:5 based on weight parts. It is not limited to use only R, G and B as a fluorescent pigment, if necessary, other pigment of different color such as gray etc. could be used.

Since the fluorescent pigments are generally powder type, they are dissolved in acetone to form a solution type, and the carbon black also can be dissolved in acetone. Herein, it is obvious for a person in the art that other solvents except the acetone could be used. In the prepared solution, the concentration ratio of pigments and acetone is 1 to 100 based on weight parts. After forming the solution, a certain mold is filled with the mixture solution and dried to harden, wherein the acetone is evaporated during drying process. In a drying method, it is obvious for a person in the art that other kinds of drying method also can used, as well as an air-drying method.

Moreover, the carbon black has a size of diameter less than 800 nm. The compounded ratio of the mixture comprising the pigment and carbon black:the background materials (resin) is 1:300˜1:800 based on weight parts.

Then, the prepared pigment mixture comprising the carbon black is mixed with the powder type of light diffuser and/or UV stabilizer using an acetone, and stirred to mix with the resin for background materials, resulting in composing a masterbatch. In the meantime, the acetone solvent (organic solvent) comprised in the masterbatch is volatilized, thus, only raw materials are remained.

Accordingly, the masterbatch has a component weight ratio as follows: the prepared pigment mixture comprising the carbon black:the light diffuser: the UV stabilizer is 1/300˜1/800:18˜23%:0.01˜0.05%, and the rest is filled with functional plastic materials (PC, PMMA, PE etc.), namely, the resin for background materials. Preferably, the UV stabilizer has 0.03% of weight rate.

3) After composing the masterbatch as like above, raw materials of the background (medium) are added with the said masterbatch to obtain a mixture, and molded into an image display according to the proper process (S130). At this time, the ratio of the masterbatch and background materials is 1:9 based on weight parts. This is just preferable one example, so the component ratio can be varied variously in the range of about 5%. For example, when the masterbatch has 5˜15% of the weight rate, the background materials can have 85˜95% of the weight rate.

Therefore, the following Table 1 shows whole component ratio according to one example of the present invention.

TABLE 1

| | | Masterbatch | | | |
|---|---|---|---|---|---|
| | | | Fluorescent Pigment | | |
| | Background | Background | mixture (comprising | light | UV |
| Ratio | Materials | materials | Carbon black) | diffuser | stabilizer |
| 100% | 90% | 7.662~8.1865% | 0.0125~0.033% | 1.8~2.3% | 0.001~0.005% |

As an example of the process, the mixture of masterbatch and background materials passes through the planographic roller to mold an image display in case of using a planographic roller. Accordingly, the molded compound for image display can be implemented into textile such as a cloth; or screen for image display; or panel form.

Although the above case relates to molding by a planographic roller, it is not limited thereto, other various process for manufacturing an image display can be used in the present invention.

The procedure of implementing an image on the image display composed as the above is below:

An incident light from projector to a display panel is diffused uniformly by a light diffuser and fluorescent pigment comprised in panel, and then scattered and reflected to realizing an image since the light diffuser and fluorescent pigment has corpuscle form. Subsequently, the incident light is filtered with carbon nanoparticles (black carbon) to increase a contrast of the display.

Furthermore, the light diffuser diffused in panel increases a color concentration to achieve a clear picture quality by color correction, and increases color brightness to achieve a high luminance. The UV stabilizer diffused uniformly in panel absorbs a near ultraviolet to lower the value of haze caused by light outside on surface of the display, resulting in improving a haze phenomenon.

Basically, the compound for display is a mixture of background materials and masterbatch, but the mixture can have a multi-layer structure showing below functions. For example, it is possible to consist of the light-transmitting layer in which the incident light from projector is transmitted according to the pixel; the light-scattering layer in which the transmitted light is scattered at various angles, resulting in forming an image screen at various angles thereby for audience; the light-diffusing layer in which a diffusion and transmission of light are promoted; and light outside-blocking layer in which the light outside such as sunlight etc. is prevented from transmitting or refracting into screen by a UV stabilizer and the like.

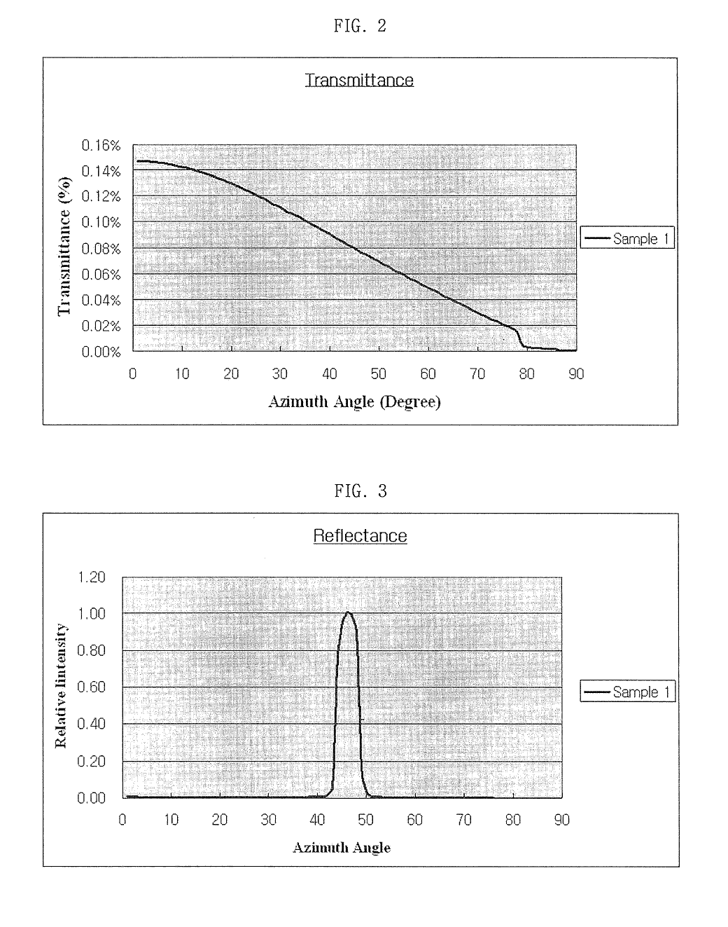

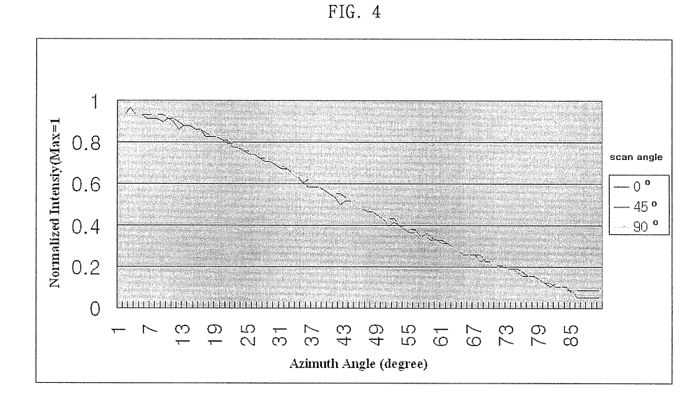

FIG. 2 is a graph showing a transmittance of the image display according to one embodiment of the present invention; FIG. 3 is a graph showing a reflectance of the image display according to one embodiment of the present invention; and FIG. 4 is a graph showing a three-dimensional transmittance of the image display according to one embodiment of the present invention, using an iconoscope.

Since FIG. 2 shows a transmittance on the waveband of 400˜700 mm using Gray Card in the image display according to one embodiment of the present invention, it proves that the image display of the present invention has a good light diffusion and an excellent viewing angle.

Moreover, FIG. 3 shows a reflectance to air layer on the waveband of 400˜700 mm in the image display according to one embodiment of the present invention, it means that the characteristics of viewing angle is excellent, except the peak values at the angle of 40˜50°.

Furthermore, FIG. 4 shows a three-dimensional transmittance using a conoscope, it proves that the present invention can be used as a display, based on the superior viewing angle property.

Therefore, background materials, optical (fluorescent) pigment, black carbon and UV stabilizer are mixed at proper ratio to form all-in-one display panel, which can improve a contrast and luminance dramatically.

### INDUSTRIAL APPLICABILITY

According to the present invention, it is possible that background materials and masterbatch are mixed at proper ratio to form one display panel.

Accordingly, such display can be applied to TV or movie screen, especially, it is very useful for large size of display more than 100 inch, compared to the traditional display having a limitation.

What is claimed is:

1. An image display comprising of background materials and masterbatch achieving a performance of the display by mixing with the background materials; wherein the masterbatch comprises fluorescent pigments of red (R), green (G) and blue (B) implementing colors, a carbon black, a light diffuser and a UV stabilizer.

2. The image display according to claim 1, wherein the background material is any one selected from PC (PolyCarbonate), PMMA (Poly Methyl Meta Acrylate), PE (Polyethylene), PP (PolyPropylene), PI (Polyimide), Urethane and glass.

3. The image display according to claim 1, wherein the red (R) is a phenyl-based pigment, the green (G) is a lumilight pigment and the blue (B) is tungstic acid calcium pigment in the fluorescent pigments.

4. The image display according to claim 1, wherein the ratio of each fluorescent pigment and carbon black is that red (R):green (G):blue (B):carbon black=1:50:80:5 based on the weight parts.

5. The image display according to claim 4, wherein the ratio of the mixture comprising the fluorescent pigments and carbon black:the background materials is 1:300˜1:800 based on the weight parts in the masterbatch.

6. The image display according to claim 1, wherein the masterbatch has a component ratio as follows: the pigment mixture comprising the carbon black:light diffuser:UV stabilizer=1/300˜1/800:18˜23%:0.01˜0.05% based on the weight parts, and the rest is filled with the background materials.

7. A method for manufacturing an image display, the said method comprises the follow three steps:
the first step of forming an pigment mixture by mixing the background materials and each fluorescent pigment powder of red (R), green (G) and blue (B) and adding with solvent thereto to re-mix with carbon black;
the second step of composing a masterbatch by adding with the solvent to the pigment mixture containing the carbon black to mix with the powder of light diffuser and UV stabilizer and then stirring to mix with the background materials; and
the third step of forming a mixture by mixing the background materials and the masterbatch and then molding a display.

8. The method for manufacturing an image display according to claim 7, wherein the background materials is any one selected from PC (PolyCarbonate), PMMA (Poly Methyl Meta Acrylate), PE (Polyethylene), PP (PolyPropylene), PI (Polyimide), Urethane and glass.

9. The method for manufacturing an image display according to claim 7, wherein the ratio of each fluorescent pigment and carbon black is that red (R):green (G):blue (B):carbon black=1:50:80:5 based on the weight parts at the first step.

10. The method for manufacturing an image display according to claim 7, wherein the ratio of the mixture comprising the fluorescent pigments and carbon black:the background materials is 1:300˜1:800 based on the weight parts in the masterbatch at the first step.

11. The method for manufacturing an image display according to claim 7, wherein the masterbatch has a component ratio as follows: the pigment mixture comprising the carbon black:light diffuser:UV stabilizer=1/300˜1/800:18˜23%:0.01˜0.05% based on the weight parts, and the rest is filled with the background materials at the second step.

12. The method for manufacturing an image display according to claim 7, wherein the ratio of the masterbatch and background materials is 1:9 based on the weight parts at the third step.
